(19) United States
(12) Patent Application Publication
(10) Pub. No.: US 2009/0289874 A1
(43) Pub. Date: Nov. 26, 2009

(54) IMAGE DISPLAY APPARATUS OF WHICH DISPLAY IS DISPOSED ON BORDER AREA AND IMAGE DISPLAY METHOD THEREOF

(75) Inventor: Kyung-mi HA, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 12/353,507

(22) Filed: Jan. 14, 2009

(30) Foreign Application Priority Data
May 22, 2008 (KR) 10-2008-0047436

(51) Int. Cl. G09G 5/00; H04N 5/445

(52) U.S. Cl. 345/1.3; 725/39; 348/836

(57) ABSTRACT

An image display apparatus and an image display method are disclosed. The image display apparatus includes a first display unit which displays a main image, and a second display unit which is disposed on a border of the first display unit and forms at least one side of a bezel. A user can thereby modify the design of the image display apparatus more diversely and easily.

### CROSS-REFERENCE TO RELATED APPLICATIONS

This application claims priority from Korean Patent Application No. 10-2008-0047436, filed on May 22, 2008, in the Korean Intellectual Property Office, the disclosure of which is incorporated herein by reference in its entirety.

### BACKGROUND OF THE INVENTION

1. Field of the Invention

Apparatuses and methods consistent with the present invention relate to providing an image display apparatus and an image display method, and more particularly, to providing an image display apparatus which displays diverse images, and an image display method thereof.

2. Description of the Related Art

With the recent diversification of television (TV) and developments of the technologies, the design of an image display device has come to be considered important as well as its function.

A bezel is disposed on a border area of a TV. The bezel design of TVs is determined in the production process of the TV, so a user should purchase a TV which the bezel design has been already determined. In order to apply a new design to the TV, a problem arises in that the user should replace the bezel or purchase a new TV.

There is demand among users for more diverse designs of TVs. Therefore, there is a need for methods for the users to modify designs of display devices more diversely and easily.

### SUMMARY OF THE INVENTION

Exemplary embodiments of the present invention overcome the above disadvantages and other disadvantages not described above. Also, the present invention is not required to overcome the disadvantages described above, and an exemplary embodiment of the present invention may not overcome any of the problems described above.

The present invention provides an image display apparatus which includes a second display unit disposed on a border of a first display unit and forming at least one side of a bezel, and an image display method thereof, so that a user can modify the design of the image display apparatus more diversely and easily.

The present invention provides an image display apparatus which includes a second display area disposed on part or all of a border area, which is outside a first display area, wherein a sub-image corresponding to the design of the border area, a sub-image including data information or EPG information, and a sub-image, which may or may not include information relevant to a main image, are displayed.

According to an aspect of the present invention, there is provided an image display apparatus comprising a first display unit which displays a main image, and a second display unit which is disposed on a border of the first display unit and forms at least one side of a bezel.

The first display unit and second display unit may be each formed of a separate panel.

The first display unit may be a center area of one panel, and the second display unit may be a border area of the panel.

The image display apparatus may further comprise a transparent bezel, wherein the second display unit is disposed to overlap with the area on which the transparent bezel is disposed.

The image display apparatus may further comprise a first driver which drives the first display unit, and a second driver which drives the second display unit.

The image display apparatus may further comprise a driver which drives the first display unit and the second display unit.

The second display unit may display an image corresponding to the bezel design.

The second display unit may display an image including data information.

The second display unit may display an image including EPG information or information relevant to the main image.

The second display unit may display a sub-image, which may be at least one of an image stored in a storage medium, an image relevant to data received by data broadcasting, and an image received through a minor channel.

The image display apparatus may further comprise a third display unit which is disposed on a border of the first display unit and is disposed on an area of the bezel area other than the area on which the second display unit is disposed.

The second display unit may display a preset image, even if the image display apparatus is in a standby mode.

The image display apparatus may be a digital TV.

According to another aspect of the present invention, there is provided an image display method, comprising displaying a main image on a first display area, and displaying a sub-image on a second display area disposed on a border of the first display area and forming at least one side of a bezel.

According to another aspect of the present invention, there is provided an image display apparatus, comprising: a display unit which includes a first display area and a second display area disposed on part or all of a border area, which is outside the first display area, and a control unit which controls a main image to be displayed on the first display area and a sub-image corresponding to the design of the border area to be displayed on the second display area.

The first display area and second display area may be each formed of a separate panel.

The first display unit may be a center area of one panel, and the second display unit may be a border area of the panel.

The image display apparatus may further comprise a transparent bezel, wherein the second display unit is disposed to overlap with the area on which the transparent bezel is disposed.

The second display area may be disposed on part or all of an area on which the bezel is disposed, and the sub-image may be an image corresponding to the bezel design.

The sub-image may be at least one of an image stored in a storage medium, an image relevant to data received by data broadcasting, and an image received through a minor channel.

According to another aspect of the present invention, there is provided an image display method of an image display apparatus which includes a first display area and a second display area disposed on part or all of a border area, which is outside the first display area, the image display method comprising displaying a main image on the first display area, and displaying a sub-image corresponding to the design of the border area on the second display area.

According to another aspect of the present invention, there is provided an image display apparatus, comprising a display unit which includes a first display area and a second display area disposed on part or all of a border area, which is outside the first display area, and a control unit which controls a main image to be displayed on the first display area and a sub-image including data information or EPG information to be displayed on the second display area.

According to another aspect of the present invention, there is provided an image display method of an image display apparatus which includes a first display area and a second display area disposed on part or all of a border area, which is outside the first display area, the image display method, comprising displaying a main image on the first display area, and displaying a sub-image including data information or EPG information on the second display area.

According to another aspect of the present invention, there is provided an image display apparatus, comprising a display unit which includes a first display area and a second display area disposed on part or all of a border area, which is outside the first display area, and a control unit which controls a main image to be displayed on the first display area and a sub-image including information relevant to the main image to be displayed on the second display area.

According to another aspect of the present invention, there is provided an image display method of an image display apparatus which includes a first display area and a second display area disposed on part or all of a border area, which is outside the first display area, the image display method, comprising: displaying a main image on the first display area, and displaying a sub-image including information relevant to the main image on the second display area.

According to another aspect of the present invention, there is provided an image display apparatus, comprising a first display unit which displays a main image, and a second display unit which is disposed on a border of the first display unit, forms at least one side of a bezel and includes a plurality of sub-display units.

The plurality of sub-display units each may display a separate sub-image.

According to another aspect of the present invention, there is provided an image display method, comprising displaying a main image on a first display unit, and displaying a sub-image on a second display unit which is disposed on a border of the first display unit, forms at least one side of a bezel, and includes a plurality of sub-display units.

### BRIEF DESCRIPTION OF THE DRAWINGS

The above and/or other aspects of the present invention will be more apparent by describing certain exemplary embodiments of the present invention with reference to the accompanying drawings, in which:

FIG. 1 is a perspective view of a TV according to an exemplary embodiment of the present invention;

FIG. 2 is a view showing a bezel provided with a second display panel according to an exemplary embodiment of the present invention;

FIG. 3 is a view showing a panel in which a first display area and a second display area are included and a transparent bezel according to another exemplary embodiment of the present invention;

FIG. 4 is a block diagram of a TV to which the present invention is applicable;

FIG. 5 is a detailed block diagram of a display unit driven using a separate driver according to an exemplary embodiment of the present invention;

FIG. 6 is a detailed block diagram of a display unit driven using a separate driver according to another exemplary embodiment of the present invention;

FIG. 7 is a flowchart explaining an image display method according to an exemplary embodiment of the present invention;

FIG. 8 is a view of a TV in which a second display area forms three sides of a border of a first display area according to another exemplary embodiment of the present invention;

FIG. 9 is a view of a TV in which a second display area forms two sides of a border of a first display area according to another exemplary embodiment of the present invention;

FIG. 10 is a view of a TV in which a second display area forms one side of a border of a first display area according to another exemplary embodiment of the present invention;

FIG. 11 is a view of a TV in which a design image and data information are simultaneously displayed on a second display area according to another exemplary embodiment of the present invention;

FIG. 12 is a view showing the case in which a screen of a second display area changes according to an exemplary embodiment of the present invention;

FIG. 13 is a block diagram of an image display apparatus according to another exemplary embodiment of the present invention;

FIG. 14 is a flow chart of an image display method according to another exemplary embodiment of the present invention; and

FIG. 15 is a block diagram of an image display apparatus according to still another exemplary embodiment of the present invention.

### DETAILED DESCRIPTION OF EXEMPLARY EMBODIMENTS

Certain exemplary embodiments of the present invention will now be described in greater detail with reference to the accompanying drawings.

In the following description, the same drawing reference numerals are used for the same elements even in different drawings. The matters defined in the description such as, detailed construction and elements, are provided to assist in a comprehensive understanding of the invention. Thus, it is apparent that the exemplary embodiments of the present invention can be carried out without those specifically defined matters. Also, well-known functions or constructions are not described in detail since they would obscure the invention with unnecessary detail.

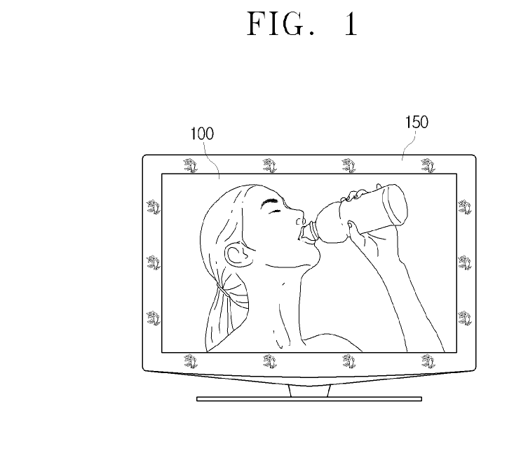

FIG. 1 is a perspective view of a TV according to an exemplary embodiment of the present invention. As shown in FIG. 1, a TV includes a first display area 100 and a second display area 150.

A main image corresponding to contents is displayed on the first display area 100 (or a first display unit). Here, the main image means an image which a user intends to view, such as a TV program or movie. Therefore, the first display area 100 corresponds to a screen of a TV.

The second display area 150 (or a second display unit) is disposed on a border of the first display area and forms at least one side of a bezel. The second display area 150 also has a shape corresponding to the bezel shape. A sub-image is displayed on the second display area 150.

The sub-image means images displayed on the second display area 150. The sub-image may be an image corresponding to the bezel design, data information (e.g. EPG information, or other data services), or an image which may or may not be relevant to the main image. However, other various sub-images may of course be displayed on the second display area 150. Any of the image information displayed as a sub-image may be related in content to the main image being displayed or conversely, the sub-image may have no relationship with the main image being displayed; thus may operate independently from the main image.

The image corresponding to the bezel design is also an image corresponding to the design of a TV. Therefore, the image information corresponding to the bezel design according to the present embodiment may be of various patterns or colors.

The image including data information may display information received through data broadcasting. The data information may, for example, be stock information, weather information, horoscope, or news. In other words, various kinds of information may be displayed on the second display area 150.

The image including EPG information may be an image displayed by reconstructing the EPG information received through a broadcasting signal. The image including the EPG information includes information such as broadcasting program titles, broadcasting times, and genres.

The image including information relevant to the main image may be an image which displays information relevant to the main image that is currently being viewed by a viewer. For example, when a travel program is being displayed on the first display area 100 as a main image, information on a place that is currently introduced, such as names of regions and local specialties, may be displayed on the second display area 150 as a sub-image. When a weather forecast is displayed on the first display area 100 as a main image, an image corresponding to the current weather may be displayed on the second display area 150 as a sub-image.

Various sub-images may be displayed on the second described area 150 as described above. The source of the various different types of images information (e.g. design image information, data information, EPG information or other types of image information) being displayed as a sub-image may be received from broadcast, internet or other external sources or may be pre-stored in the TV. The sub-image may be an image file stored in a storage medium. More specifically, the sub-image may be stored in a USB memory connected through a USB port disposed on the TV, a memory inside the TV, a CD, or a DVD, and the second display area 150 may display the stored image information as a sub-image.

The sub-image may be an image generated using data information received through a data broadcasting signal, as another example. More specifically, the TV receives data information through data broadcasting. The TV generates an image which displays the data information on the second display area 150. The generated image is displayed on the second display area 150.

The sub-image may be an image received through a minor channel of a broadcasting channel, as another example. The broadcasting channel is formed of a plurality of minor channels. Therefore, a broadcasting provider may provide a sub-mage using any one of the minor channels as a channel for transmitting the sub-image. The TV displays the sub-image received through the minor channel on the second display area 150.

The sub-image may also be received through a separate broadcasting channel. In this case, the TV should have a separate tuner for receiving the sub-image.

The sub-image may be provided by various methods as described above.

The second display area 150 may have a shape corresponding to the bezel shape and is disposed on the area on which the bezel is disposed, thereby displaying the image corresponding to the TV design.

Here, the bezel shape is not limited to a quadrangle. In other words, the bezel shape may have various shapes and may be curved. For example, the bezel shape may have straight lines at the top, left and right sides, and may be curved at the bottom.

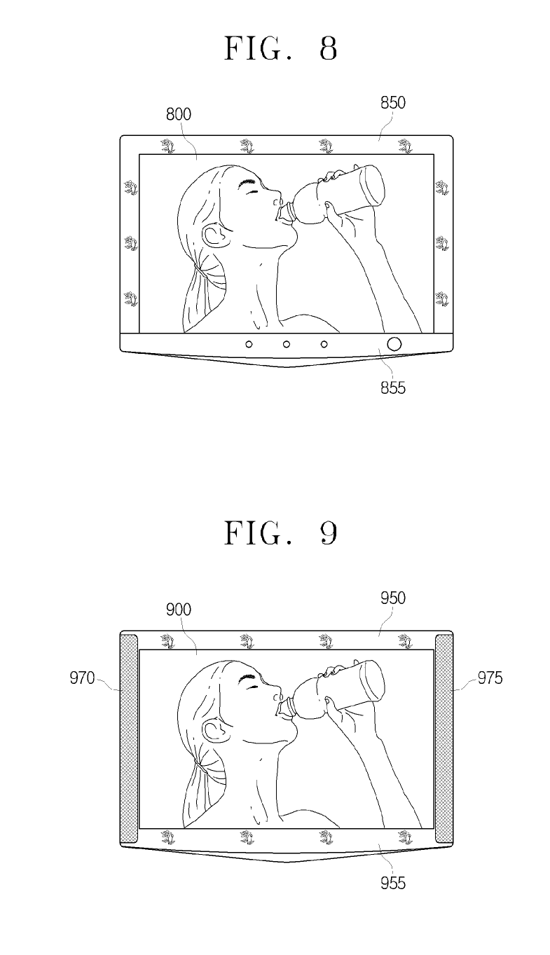

The second display area 150 may be disposed on all or part of the area on which the bezel is disposed. In other words, the second display area 150 may also be a bezel shape surrounding at least one side of four sides of the first display area 100, in addition to a bezel shape surrounding all four sides of the border of the first display area 100. This feature will be described later with reference to FIGS. 8 to 10.

The sub-image may or may not be continuously displayed on the second display area 150, even if the TV is in a standby mode. Here, the standby mode means a mode in which the TV is only plugged in, but the power button has not been pressed. If the sub-image is continuously displayed even if the TV is in a standby mode, the user may feel as if the image displayed on the second display area 150 is a fixed bezel design of the TV. The user may be offered one of a plurality of default bezel designs to choose from (e.g. in the setting menu of the TV) so that the chosen default bezel design may be displayed even in the standby mode.

On the second display area 150, the displayed sub-image may be changed diversely and easily as described above. Therefore, the TV may various represent designs of the bezel through the second display area 150.

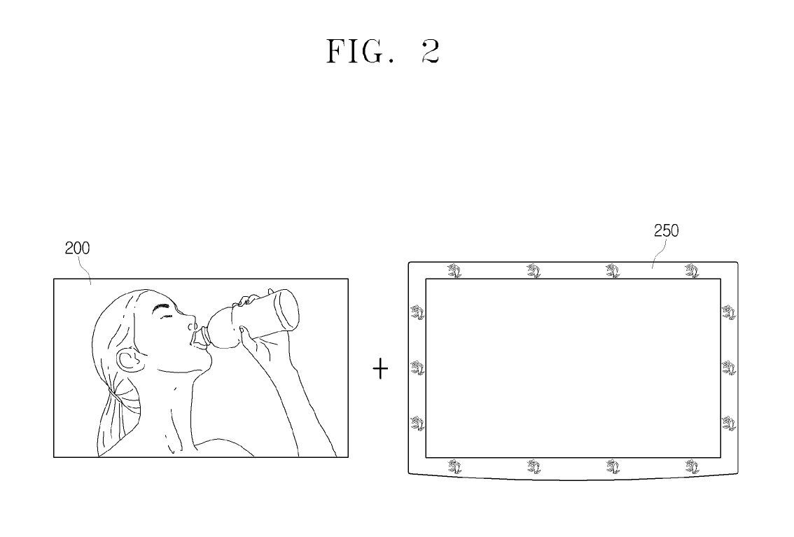

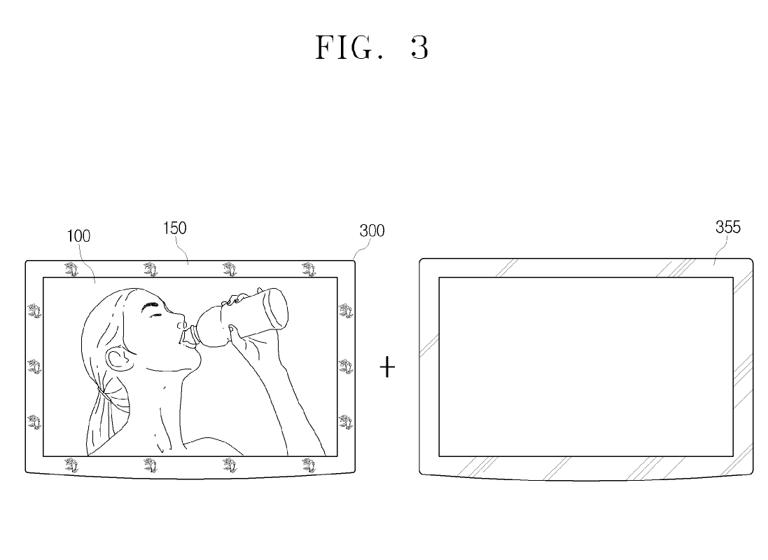

The second display area 150 may be implemented as a separate panel from the first display area 100, or may be implemented using an outer area of the first display panel. This feature will be described below with reference to FIGS. 2 and 3.

FIG. 2 is a view showing a bezel provided with a second display panel 250 according to an exemplary embodiment of the present invention. As shown in FIG. 2, a TV includes a first display panel 200 and a second display panel 250.

The first display panel 200 is a panel which displays a first display panel 100. The first display panel 200 corresponds to a TV panel generally used.

The second display panel 250 is separate from the first display panel 200. The second display panel 250 has a bezel shape and is disposed on the area on which the bezel is disposed, instead, perform the function of the bezel. However, a transparent bezel may of course be additionally disposed on the second display panel 250.

In the present embodiment, the second display panel 250 is formed of one separate panel, however the second display panel 250 may of course be formed of three or four display panels or a plurality of sub-panels. For example, the second display panel 250 may be formed of four sub-panels disposed respectively on the top, bottom, left and right sides of the bezel.

When the second display panel 250 is implemented as a separate panel as described above, the second display panel 250 can be operated, irrespective of whether the first display panel 200 is being operated.

FIG. 3 is a view showing a panel including a first display area and a second display area, and a transparent bezel according to another exemplary embodiment of the present invention.

As shown in FIG. 3, a TV includes a combined first and second display panel 300, and a transparent bezel 355.

The combined first and second display panel 300 includes a first display area 100 and a second display area 150. Therefore, the combined first and second display panel 300 is manufactured to be larger than the panel of a general TV.

The transparent bezel 355 is disposed to overlap with the area on which the second display area 150 is disposed.

In the present embodiment, the second display area 150 is explained as having one area, however, the second display area 150 may of course have a plurality of areas or sub-areas. For example, the second display area 150 may be divided into a total of four sub-areas, such as top, bottom, left and right sub-areas. In this case, separate sub-images are displayed on the top, bottom, left and right sub-areas, respectively.

If the second display area 150 and the first display area 100 are implemented as a single panel as described above, the panel can be more simply manufactured.

The second display area 150 may be implemented by either of two methods, as described above.

Hereinafter, a detailed constitution of a TV will be described with reference to FIG. 4. FIG. 4 is a block diagram of a TV to which the present invention is applicable.

As shown in FIG. 4, the TV includes a broadcasting receiving unit 410, a signal separating unit 420, an A/V processing unit 430, a audio output unit 440, a display unit 450, a storage unit 460, a control unit 470, a remote control receiving unit 480, and a remote controller 490.

The broadcasting receiving unit 410 receives and demodulates broadcasting by wire or wirelessly from a broadcasting station or a satellite.

The signal separating unit 420 separates broadcasting signals into an image signal, an audio signal, and a data broadcasting signal. The signal separating unit 420 then transmits the image signal and the audio signal to the A/V processing unit 430, and the data broadcasting signal to the control unit 470.

The A/V processing unit 430 performs signal processing, such as video decoding, video scaling, or audio decoding, on the image signal and the audio signal input from the signal separating unit 420.

The A/V processing unit 430 outputs the image signal to the display unit 450, and outputs the audio signal to the audio output unit 440.

The A/V processing unit 430 also processes and transmits the sub-image signal input from the storage unit 460 to the display unit 450.

The audio output unit 440 outputs audio output from the A/V processing unit 430 through a speaker, or outputs the audio to external devices (for example, an external speaker) connected through external output terminals.

The display unit 450 displays an image output from the A/V processing unit 430 on a screen. In particular, the display unit 450 displays a main image and a sub-image. Here, the main image means an image for content which a user intends to view, such as a TV program and movie. The sub-image may be an image relevant to the design stored in the storage unit 460 or an image relevant to the data broadcasting signal received through the broadcasting receiving unit 410. However, any sort of sub-image may be displayed on the second display area 150.

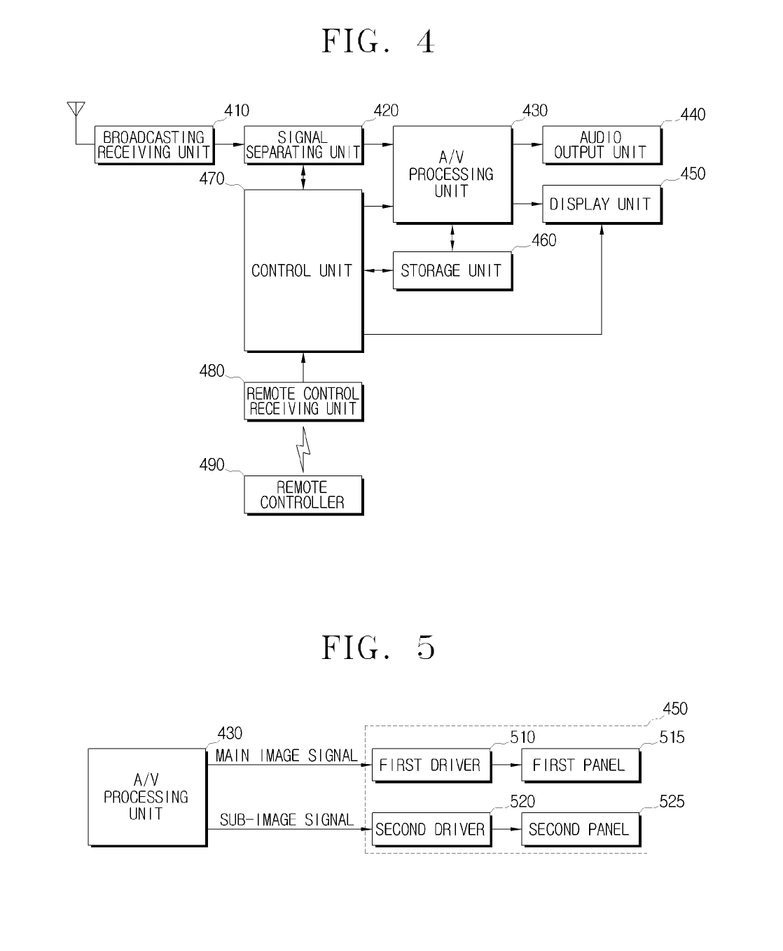

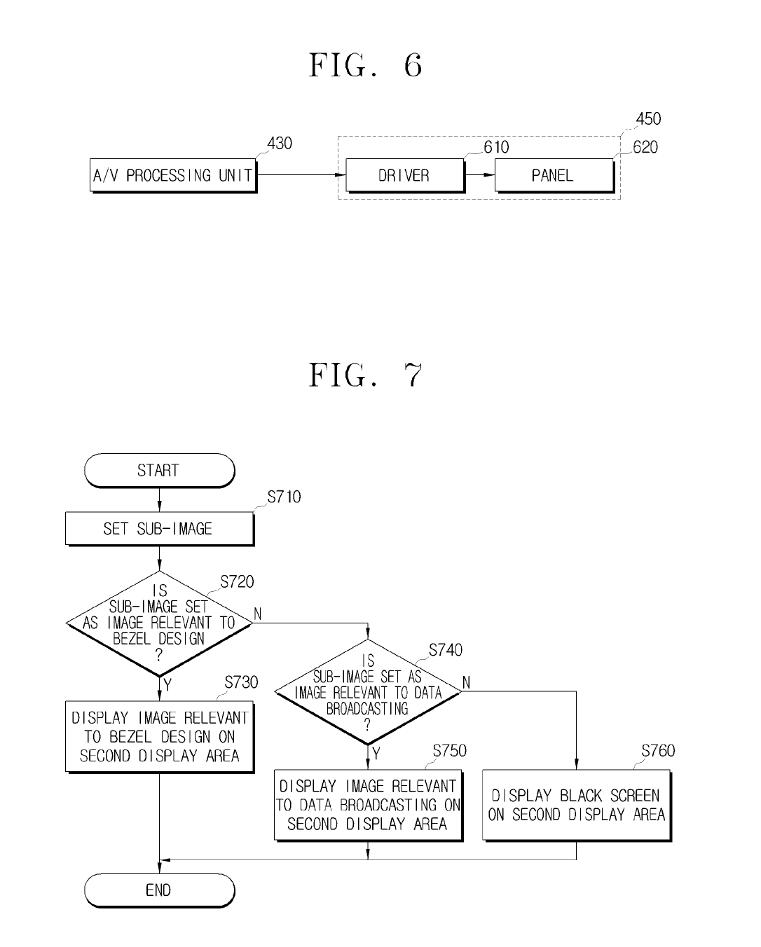

The display unit 450 will be described in detail with reference to FIGS. 5 and 6.

The storage unit 460 stores files for recorded images. The storage unit 460 also stores sub-image files to be displayed on the second display area 150. The storage unit 460 may be implemented as a various different types including hard disk or a non-volatile memory.

The remote controller 490 receives and transmits a user's operation through the remote control receiving unit 480.

The control unit 470 determines the user's instructions based on the content of the user's operation transmitted from the remote controller 490, and controls the entire operation of the TV according to the user's instructions.

The control unit 470 controls the A/V processing unit 430 and the display unit 450 in order that the main image is displayed on the first display area 100 and the sub-image is displayed on the second display area 150.

Hereinafter, an A/V processing unit 430 and a display unit 450 will be described in detail with reference to FIGS. 5 and 6. FIG. 5 is a detailed block diagram of a display unit driven using a separate driver according to an exemplary embodiment of the present invention.

The display unit 450 of FIG. 5 corresponds to the embodiment shown in FIG. 2. When the display unit is implemented as a separate display panel, as shown in FIG. 2, the drivers thereof should also be separate. Therefore, as shown in FIG. 5, the display unit 450 includes a first driver 510, a first panel 515, a sub-driver 520, and a second panel 525.

The A/V processing unit 430 divides the input image signals into a main image signal and a sub-image signal. The A/V processing unit 430 transmits the main image signal to the first driver 510, and transmits the sub-image signal to the second driver 520.

The first driver 510 drives the first panel 515, and the second driver 520 drives the second panel 525.

If the first panel 515 and the second panel 525 are driven using separate drivers as described above, each panel can be driven independently. Therefore, only the sub-panel 525 is driven when the TV is in a standby mode, making it possible to use the second display 150 more efficiently.

In the present embodiment, the second display area 150 is explained to be formed as one panel, but it may be formed as a plurality of sub-panels. In this case, as many drivers are required as these are sub-panels. For example, when the second display area 150 is formed as four sub-panels of the bezel area, on the top, bottom, left, and right, respectively, the second driver 520 is formed as four sub-drivers which drive the four respective sub-panels. This is one of the methods to drive a panel of which the center is empty, such as the second display panel 250 of FIG. 2.

FIG. 6 is a detailed block diagram of a display unit driven with a separate driver according to another exemplary embodiment of the present invention.

The display unit 450 of FIG. 6 corresponds to the embodiment shown in FIG. 3. When the display unit is implemented as one display panel, as shown in FIG. 3, there is also one driver thereof. Therefore, as shown in FIG. 6, the display unit 450 includes a driver 610 and a panel 620.

The A/V processing unit 430 combines the input image signal and the sub-signal of the main image signal into one screen, and transmits the combined image signal to the driver 610.

When the display unit is implemented using one driver and one panel as described above, the display unit may be manufactured using a similar process to an existing TV, making it possible to manufacture the TV according to the present embodiment more easily.

Hereinafter, the operation of a control unit 470 which controls a sub-image to be displayed on a second display area 150 will be described in detail with reference to FIG. 7. FIG. 7 is a flowchart explaining an image display method according to an exemplary embodiment of the present invention.

First, the control unit 470 receives the sort of sub-image set by a user (S710). The sort of sub-image may be an image relevant to a bezel design or an image relevant to data broadcasting.

When the sub-image is set to be an image relevant to the bezel design (S720-Y), the control unit 470 controls the image relevant to the bezel design to be displayed on a second display area 150 (S730).

The image relevant to the bezel design is stored in a storage unit 460. Therefore, the control unit 470 controls the image relevant to the bezel design stored in the storage unit 460 to be transmitted to an A/V processing unit 430, and the A/V processing unit 430 processes and outputs the image relevant to the bezel design to a display unit 450.

When the sub-image is set to be an image relevant to the data broadcasting (S740-Y), the control unit 470 controls the image relevant to the data broadcasting to be displayed on the second display area 150 (S750).

The image relevant to the data broadcasting is received through a broadcasting receiving unit 410. Therefore, the control unit 470 generates and transmits an image relevant to the received data broadcasting to the A/V processing unit 430. The A/V processing unit 430 processes and outputs the image relevant to the data broadcasting to the display unit 450.

In contrast, when the sub-image is not set (S740-N), the control unit 470 controls a black screen to be displayed on the second display area 150 (S760). The black screen is represented by displaying a black image or by controlling the second display area 150 not to be driven.

The control unit 470 displays the sub-image on the second display area 150 through the process as described above.

Hereinafter, another exemplary embodiment of the present invention will be described. FIG. 8 is a view of a TV in which a second display area forms three sides of a border of a first display area according to another exemplary embodiment of the present invention.

As shown in FIG. 8, the TV includes a first display area 800, a second display area 850, and a button area 855.

In FIG. 8, the three sides of the border of the first display area 800 are disposed as the second display area 850. The button area 855 provided with buttons for controlling the TV is disposed on the bottom area of the border of the first display area 800.

As described above, the second display area 850 having a shape corresponding to a bezel shape may be disposed on an area other than the button area 855 in which the buttons are disposed.

FIG. 9 is a view of a TV in which a second display area forms two sides of a border of a first display area according to another exemplary embodiment of the present invention.

As shown in FIG. 9, the TV includes a first display area 900, second display areas 950, 955, and speaker areas 970, 975.

In FIG. 9, the two sides of the border of the first display area 900 form the second display areas 950, 955. The speaker areas 970, 975 provided with speakers are disposed to the left and right of the border of the first display area 900.

The speakers are generally disposed to the left and right of the first display area 900. In this case, the second display areas 950, 955 may be disposed on the top and bottom areas of the first display area 900.

As described above, the second display areas 950, 955 having a shape corresponding to the bezel shape may be implemented to be disposed on an area other than the speaker areas 970, 975.

FIG. 10 is a view of a TV in which a second display area forms one side of a border of a first display area according to another exemplary embodiment of the present invention.

As shown in FIG. 10, the TV includes a first display area 1000, a second display area 1050, speaker areas 1070, 1075, and a button area 1080.

In FIG. 10, one side of the border of the first display area 1000 forms the second display area 1050. The speaker areas 1070, 1075 provided with speakers are disposed to the left and right of the border of the first display area 1000, and the button area 1080 provided with bottoms is disposed to the bottom.

As described above, the second display area 1050 having a shape corresponding to the bezel shape may be implemented to be disposed on an area other than the speaker areas 1070, 1075 and the button area 1080.

As described above, the second display area of the TV may be disposed on a part or all of the area in which the bezel is to be disposed.

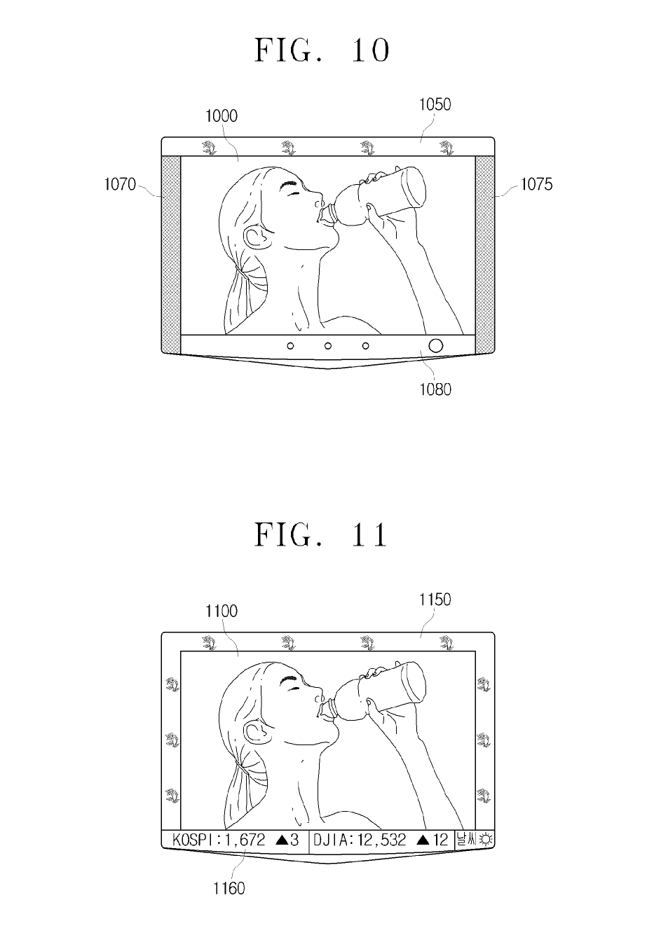

FIG. 11 is a view of a TV in which a design image and data information are simultaneously displayed on a second display area according to another exemplary embodiment of the present invention.

As shown in FIG. 11, the TV includes a first display area 1100 and second display areas 1150, 1160.

In FIG. 11, the second display areas 1150, 1160 consist of an area 1150 in which an image relevant to a bezel design is displayed and an area 1160 in which an image relevant to data broadcasting is displayed.

As described above, various images may be displayed on the second display area.

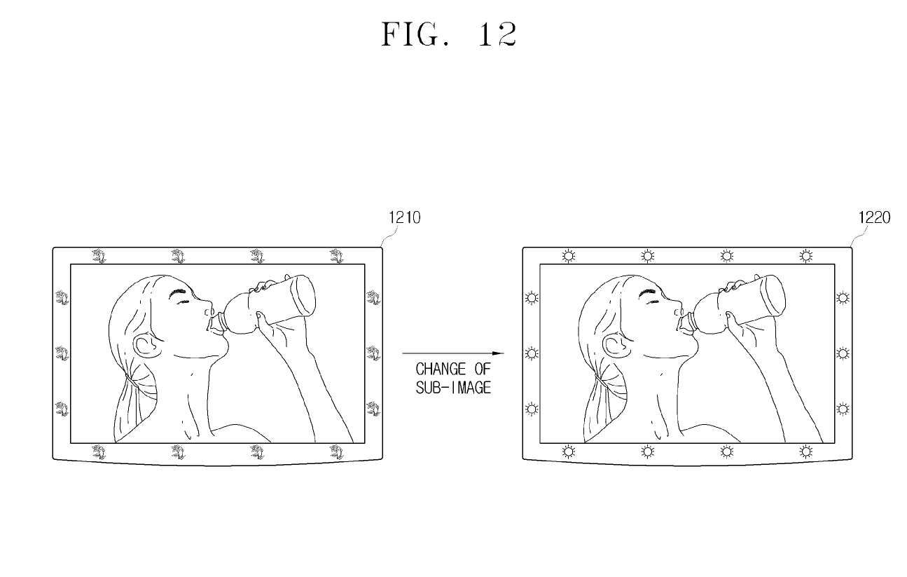

FIG. 12 is a view showing the case in which a screen of a second display area changes according to an exemplary embodiment of the present invention.

As shown in FIG. 12, it can be appreciated that a sub-image displayed on the second display area changes from an image 1210 displaying a flower to an image 1220 displaying the sun.

As described above, a user may obtain the effect that the TV design is changed by changing the sub-image displayed on the second display area.

In the present embodiment, the second display area 150 has been explained as displaying the image relevant to the bezel design or the image relevant to the data broadcasting, but, any other images can be displayed on the second display area 150.

For example, menu for controlling a TV may be displayed on the second display area 150. Also, part or all of the second display area 150 may be implemented as a touch screen so that a user can select a menu for controlling the TV using the touch screen.

In the present embodiment, the second display area 150 has been explained as having a quadrangular shape, but the second display area 150 may have other shapes. In other words, the second display area 150 may change according to the outer design shape of the TV.

In the present embodiment, the second display area 150 has been explained as having a single area, but the second display area 150 may of course be implemented to have a plurality of areas. In other words, the second display area 150 may be implemented as a plurality of areas in which the bezel is disposed, and may include a plurality of panels and a plurality of drivers.

In the present embodiment, the image display apparatus has been explained as being a TV, but any image display apparatus is applicable. For example, the technical idea of the present invention is applicable to a digital TV, a monitor, an MP3 player, a PMP, a cellular phone, a laptop computer, and an electronic dictionary.

Hereinafter, another exemplary embodiment of the present invention will be described with reference to FIGS. 13 to 15.

FIG. 13 is a block diagram of an image display apparatus according to another exemplary embodiment of the present invention.

As shown in FIG. 13, an image display apparatus of another exemplary embodiment of the present invention includes a first display unit 1310 and a second display unit 1320.

The first display unit 1310 displays a main image.

The second display unit 1320 is disposed on a border of the first display unit 1310 and forms at least one side of a bezel.

The second display unit 1320, which is disposed on the border of the first display unit and forms at least one side of the bezel, may also include a plurality of sub-display units.

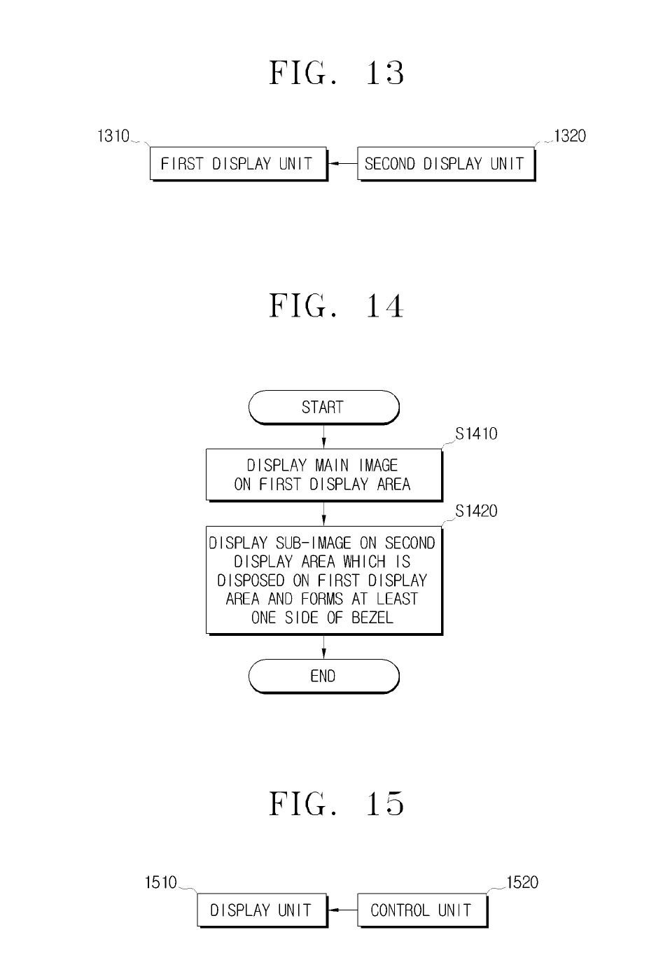

FIG. 14 is a flowchart of an image display method according to another exemplary embodiment of the present invention.

According to the image display method of FIG. 14, an image display apparatus displays a main image on a first display area (S1410).

The image display apparatus displays a sub-image on the second display area which is disposed on the border of the first display area and forms at least one side of the bezel (S1420).

FIG. 15 is a block diagram of an image display apparatus according to still another exemplary embodiment of the present invention. As shown in FIG. 15, the image display apparatus of FIG. 15 includes a display unit 1510 and a control unit 1520.

The display unit 1510 includes a first display area and a second display area disposed on part or all of a border area outside the first display area.

The control unit 1520 controls a main image to be displayed on the first display area, and a sub-image corresponding to the design of the border area to be displayed on the second display area.

The control unit 1520 may also control the main image to be displayed on the first display area, and the sub-image including EPG information to be displayed on the second display area.

The control unit 1520 may also control the main image to be displayed on the first display area, and the sub-image including information relevant to the main image to be displayed on the second display area.

The foregoing exemplary embodiments and advantages are merely exemplary and are not to be construed as limiting the present invention. The present teaching can be readily applied to other types of apparatuses. Also, the description of the exemplary embodiments of the present invention is intended to be illustrative, and not to limit the scope of the claims, and many alternatives, modifications, and variations will be apparent to those skilled in the art.

1. An image display apparatus, comprising:
a first display unit which displays a main image; and
a second display unit which is disposed on a border of the first display unit and forms at least one side of a bezel.

2. The image display apparatus as claimed in claim 1, wherein the first display unit and second display unit are each formed of a separate panel.

3. The image display apparatus as claimed in claim 1, wherein the first display unit is a center area of one panel, and the second display unit is a border area of the panel.

4. The image display apparatus as claimed in claim 3, further comprising:
a transparent bezel,
wherein the second display unit is disposed to overlap with the area on which the transparent bezel is disposed.

5. The image display apparatus as claimed in claim 1, further comprising:
a first driver which drives the first display unit; and
a second driver which drives the second display unit.

6. The image display apparatus as claimed in claim 1, further comprising:
a driver which drives the first display unit and the second display unit.

7. The image display apparatus as claimed in claim 1, wherein the second display unit displays an image corresponding to the bezel design.

8. The image display apparatus as claimed in claim 1, wherein the second display unit displays an image including data information.

9. The image display apparatus as claimed in claim 1, wherein the second display unit displays an image including EPG information or information relevant to the main image.

10. The image display apparatus as claimed in claim 1, wherein the second display unit displays a sub-image, and the sub-image is at least one of an image stored in a storage medium, an image relevant to data received by data broadcasting, and an image received through a minor channel.

11. The image display apparatus as claimed in claim 1, further comprising:
a third display unit which is disposed on a border of the first display unit and is disposed on an area of the bezel area other than the area on which the second display unit is disposed.

12. The image display apparatus as claimed in claim 1, wherein the second display unit displays a preset image even if the image display apparatus is in a standby mode.

13. The image display apparatus as claimed in claim 1, wherein the image display apparatus is a digital TV.

14. An image display method, comprising:
displaying a main image on a first display area; and
displaying a sub-image on a second display area disposed on a border of the first display area and forming at least one side of a bezel.

15. An image display apparatus, comprising:
a display unit which includes a first display area and a second display area disposed on part or all of a border area, which is outside the first display area;
a control unit which controls a main image to be displayed on the first display area and a sub-image corresponding to the design of the border area to be displayed on the second display area.

16. The image display apparatus as claimed in claim 15, wherein the first display area and second display area are each formed of a separate panel.

17. The image display apparatus as claimed in claim 15, wherein the first display unit is a center area of one panel, and the second display unit is a border area of the panel.

18. The image display apparatus as claimed in claim 17, further comprising:
a transparent bezel,
wherein the second display unit is disposed to overlap with the area on which the transparent bezel is disposed.

19. The image display apparatus as claimed in claim 15, wherein the second display area is disposed on part or all of an area on which the bezel is disposed, and the sub-image is an image corresponding to the bezel design.

20. The image display apparatus as claimed in claim 15, wherein the sub-image is at least one of an image stored in a storage medium, an image relevant to data received by data broadcasting, and an image received through a minor channel.

21. An image display method of an image display apparatus which includes a first display area and a second display area disposed on part or all of a border area, which is outside the first display area, the image display method comprising:
displaying a main image on the first display area; and
displaying a sub-image corresponding to the design of the border area on the second display area.

22. An image display apparatus, comprising:
a display unit which includes a first display area and a second display area disposed on part or all of a border area, which is outside the first display area; and
a control unit which controls a main image to be displayed on the first display area and a sub-image including data information or EPG information to be displayed on the second display area.

23. An image display method of an image display apparatus which includes a first display area and a second display area disposed on part or all of a border area, which is outside the first display area, the image display method comprising:
displaying a main image on the first display area; and
displaying a sub-image including data information or EPG information on the second display area.

24. An image display apparatus, comprising:
a display unit which includes a first display area and a second display area disposed on part or all of a border area, which is outside the first display area; and
a control unit which controls a main image to be displayed on the first display area and a sub-image including information relevant to the main image to be displayed on the second display area.

25. An image display method of an image display apparatus which includes a first display area and a second display area disposed on part or all of a border area, which is outside the first display area, the image display method comprising:
displaying a main image on the first display area; and
displaying a sub-image including information relevant to the main image on the second display area.

26. An image display apparatus, comprising:
a first display unit which displays a main image; and
a second display unit which is disposed on a border of the first display unit, forms at least one side of a bezel and includes a plurality of sub-display units.

27. The image display apparatus as claimed in claim 26, wherein each of the plurality of sub-display units displays a separate sub-image.

28. An image display method in a display apparatus, comprising:
displaying a main image on a first display unit; and
displaying a sub-image on a second display unit which is disposed on a border of the first display unit, the second display unit forming at least one side of a bezel of the display apparatus.

29. The image display method of claim 28, wherein the main image is included in a digital broadcast signal.

30. The image display method of claim 29, wherein the sub-image is an image having a predetermined pattern or color.

31. The image display method of claim 30, wherein the sub-image is pre-stored in the display apparatus.

32. The image display method of claim 30, wherein the sub-image is stored on a USB memory connectable to the display apparatus.

33. The image display method of claim 29, wherein the sub-image corresponds to an EPG information.

34. The image display method of claim 33, wherein the EPG information is received in the broadcast signal.

35. The image display method of claim 29, wherein the sub-image corresponds to information independent from the main image.

36. The image display method of claim 29, wherein the sub-image corresponds to information related to the main image currently being displayed.

37. The image display method of claim 30, wherein the sub-image is displayed even if the display apparatus is in the standby mode.

38. The image display method of claim 37, wherein the sub-image is selectable as a default sub-image and the selected default sub-image is displayed in the standby mode.

39. The image display method of claim 35, wherein the sub-image is displayed even if the display apparatus is in the standby mode.

40. The image display method of claim 39, wherein the information corresponding to the sub-image is received through the external network.

41. The image display method of claim 39, wherein the information corresponding to the sub-image is received through the broadcast signal.

42. The image display method of claim 28, wherein the second display unit is disposed on the top-side of the bezel of the display apparatus.

43. The image display method of claim 36, wherein the sub-image includes information for conveying additional information regarding the image displayed as the main image.

44. The image display method of claim 43, wherein the information corresponding to the sub-image is received through the external network.

45. The image display method of claim 43, wherein the information corresponding to the sub-image is received in the broadcast signal.

46. The image display method of claim 45, wherein the information corresponding to the sub-image is received in a different channel from a channel for receiving the main image.

47. The image display method of claim 46, wherein the information corresponding to the sub-image is received in a different minor channel of a same major channel for receiving the main image in a digital television broadcast.
